(19) United States
(12) Patent Application Publication
(10) Pub. No.: US 2012/0102226 A1
(43) Pub. Date: Apr. 26, 2012

(54) APPLICATION SPECIFIC WEB REQUEST ROUTING

(75) Inventors: Alexander Hopmann, Seattle, WA (US); Eric Fox, Seattle, WA (US); Tyler Furtwangler, Sammamish, WA (US)

(73) Assignee: MICROSOFT CORPORATION, Redmond, WA (US)

(21) Appl. No.: 13/163,140

(22) Filed: Jun. 17, 2011

Related U.S. Application Data
(63) Continuation-in-part of application No. 12/908,724, filed on Oct. 20, 2010.

(51) Int. Cl. G06F 15/16

(52) U.S. Cl. 709/241; 709/238

(57) ABSTRACT

Web request routers are used to route requests to content within a network. The web request routers run on general purpose computing devices that are configured to receive requests, parse the requests and route the requests to the appropriate destination. The web request routers may be configured to perform different routing methods and operations. For example, the web request routers may route requests based on: a type of network traffic (e.g. user/machine); application specific logic, URL patterns and/or other programmed logic. The web request routers may be configured to route the request based on a determined affinity (e.g. document, Uniform Resource Locator (URL), directory path, site collection) of the request. The web request routers may also be configured to perform QOS operations such as auditing, logging, metering, throttling network traffic, prohibiting network traffic and the like.

### RELATED APPLICATIONS

This application is a continuation-in-part and claims the benefit under 35 U.S.C. 120 of U.S. patent application Ser. No. 12/908,724, entitled “Routing Traffic in an Online Service With High Availability” filed on Oct. 20, 2010, which is hereby incorporated by reference in its entirety.

### BACKGROUND

Traditional network load balancer Traditional network load balancer devices are very expensive dedicated hardware devices for routing requests. These devices may be configured to perform layer-4 and layer-7 routing. Layer-7 is performance intensive and layer-4 is limited for customizing the routing behavior of requests. As a network grows, a bottleneck may be created causing the network traffic to slow down.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Web request routers are used to route requests to content within a network. The web request routers run on general purpose computing devices that are configured to receive requests, parse the requests and route the requests to the appropriate destination. The web request routers may be configured to perform different routing methods and operations. For example, the web request routers may route requests based on: a type of network traffic (e.g. user/machine); application specific logic, URL patterns and/or other programmed logic. The web request routers may be configured to route the request based on a determined affinity (e.g. document, Uniform Resource Locator (URL), directory path, site collection, one or more properties of the underlying HTTP protocol such as cookies, user agent, HTTP versions . . . , and the like) of the request. The web request routers may also be configured to perform QOS operations such as auditing, logging, metering, throttling network traffic, prohibiting network traffic and the like.

### BRIEF DESCRIPTION OF THE DRAWINGS

FIG. 1 illustrates a routing system using web request routers;

FIG. 2 shows an example system 200 for routing requests using web request routers in a network including front-end and back-end servers for an online service;

FIG. 3 illustrates an overview process for using web request routers to route requests;

FIG. 4 shows different exemplary operations that may be performed by a web request router; and

FIG. 5 shows an illustrative computer architecture.

### DETAILED DESCRIPTION

Referring now to the drawings, in which like numerals represent like elements, various embodiment will be described.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

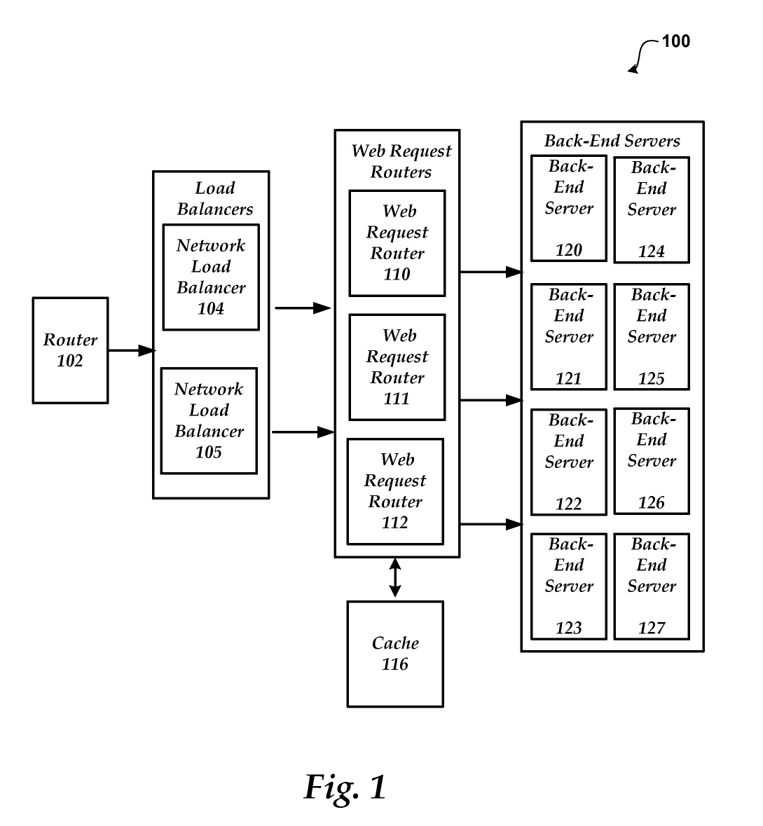

FIG. 1 shows a routing system using web request routers. As illustrated, system 100 includes router 102, network load balancers 104-105, web request routers 110-112, back-end servers 120-127, and cache 116. Greater or fewer routers, network load balancers, web request routers, and back-end servers can be used. Additionally, some of the functionality provided by the components in system 100 may be performed by other components. For example, load balancing may be performed by a different computing device instead of using dedicated network load balancers (e.g. web request routers 110-112 and/or some other general purpose computing device).

Router 102 routes data packets across networks. Generally, router 102 uses the address in the data packet to determine where to forward the packet to network load balancers 104-105 or some other destination.

Load balancers 104-105 may be implemented as dedicated network devices and/or some/all of the functionality that is provided by a load balancer may be performed by other computing devices (e.g. web request routers 110-112 or some other set of computing devices (not shown)). According to an embodiment, when network load balancers are dedicated load balancers, load balancers 104-105 operate at a lower TCP/IP layer (e.g. layer 4 as compared to layer 7) such that each load balancer can handle more requests. The load balancers 104-105 may also operate at a different layer. For example, the load balancers may be layer-3 devices that act as routes but perform load balancing. When a load balancer receives a request, the load balancer directs the request to one of the available web request routers. Different methods may be used to route the request to a web request router (e.g. round robin, based on load values, based on load values and the like). Typically, traditional load balancers are dedicated hardware devices that are expensive as compared to general purpose computing devices.

Web request routers 110-112 direct requests to one or more back-end servers 120-127. Web request routers provide a scalable request router that generally operate at a higher TCP/IP layer (e.g. layer 7) as compared to the dedicate network load balancers. According to an embodiment, the web request routers are implemented as a general purpose computing server running in MICROSOFT's INTERNET INFORMATION SERVICES (IIS) FOR WINDOWS SERVER. Generally, IIS is a flexible, secure and easy-to-manage Web server for Web hosting (e.g. from media streaming to web application hosting). Web request routers 110-112 are inexpensive as compare to dedicated hardware computing devices. For example, web request routers may be implemented on commodity servers that have low memory and processing specifications.

After receiving a request, a web request router receiving the request determines a destination of the request (e.g. back-end servers 120-127). The web request router may perform different operations to determine the destination. Generally, the web request router uses the HTTP protocol to parse the request to determine a destination for the request. In many situations, the back-end server and/or the pool of back-end servers to which to direct the request is selected using a host-header that specified in the request. The host-header may be looked up in a cache (e.g. cache 116) and that lookup may involve applying some predetermined rules. For example, when a web request router receives a Uniform Resource Location (URL) request of the form xxxx-yyyy.sharepoint.com, the web request router may look up the xxxx portion in the cache and any value of yyyy is sent to the same set of servers. The web request router may also perform other logic to determine the destination of the request.

The web request router may direct the request based on an affinity of the request. For example, the web request router may be configured to create/use affinities for: individual files, specific URLs, directory paths, types of files, site collections, one or more properties of the underlying HTTP protocol such as cookies, user agent, HTTP versions . . . , and the like. For example, an affinity may be created and stored (e.g. in cache 116) that directs a web request router to use back-end server 120 to service requests for “document 1” whereas a request for “site collection 1” may be directed to back-end servers 124 and 125. An affinity may be created for one or more back-end servers to receive requests relating to requests including a matching pattern within a URL (e.g. the web request router could detect requests including the pattern “WordViewer.aspx in the URL and based on the affinity for this pattern direct the request to the one or more designated back-end servers. An affinity may be created that specifies that any request that includes a specific address or portion of the address is to be served by one or more of the back-end servers.

The web request router may be configured to route the request based on the user from whom the request is received. For example, one or more users may be directed to a first set of back-end servers and one or more other users may be directed to a second set of back-end servers. According to an embodiment, the user is determined based on authentication information (e.g. received in a cookie). The web request router may examine cache 116 and/or some other location to determine where to route the request based on who the request is received from.

The web request router may be configured to dynamically change a routing of a request based on a setting configured by a client, such as a setting received by a client and/or a setting received from another computing device (e.g. set at an application server and/or client). For example, a user may set an option using a client-based application to route traffic differently to test a new feature. For example based on a cookie (set out-of-band by a client application) the requests received by the web request router may be routed to a newer/different version of the software, allowing an administrator/user to preview the new version without expositing it to their other users. Changing the routing of the web request routers based on client based application setting can also be used for other purposes (e.g. internal test teams to verify new functionality without exposing it to real end-users). Generally, different users may be exposed to different content based on setting a value within a client-based application.

The web request router may determine a type of the network traffic (user based/machine/administrative based) and route the traffic based on the determined type of traffic. For example, the web request router may route user based traffic to a first set of back-end servers, route machine based traffic to a second set of back-end servers and route administrative traffic to yet another set of back-end servers. The web request router may also prioritize the request based on the type of network traffic (e.g. user based traffic receives priority over machine based traffic).

The web request routers may also be configured to perform Quality of Service (QOS) operations. Many different operations may be performed by the web request routers (e.g. metering network traffic; auditing network traffic; logging network traffic; billing and controlling network traffic). For example, a web request router may reject network traffic that is determined to come from an unauthorized source. In this way, the back-end servers do not receive the unauthorized traffic and spend time processing the unauthorized traffic. The web request router may also throttle the traffic based on the request. For example, some users may be limited to a certain bandwidth/amount of content. The web request routers may also be configured for services that require billing of usage. For example, the web request routers may be configured to log and measure the load (both the number of requests, as well as bandwidth in both directions). The web request routers may also throttle sites that might have paid for only a lower amount of traffic if those sites should have a sudden spike in popularity.

The web request routers may also be configured to re-route a request to another destination outside and/or within the network of the web request router. For example, the web request routers may know where requested content has been moved that is not yet reflected by the Domain Name System (DNS). In this case, the web request router may access the location of where the content has been moved from cache 116 (or some other location) and re-route the request to the location of the content before the DNS has updated the location of the content.

The web request routers may also route traffic based on a time of the day and/or load on the back-end server(s) that are configured to receive the request. For example, during prescribed hours of the day, requests meeting a certain condition (e.g. user traffic) are directed to a first set of back-end server whereas requests not meeting the condition are directed to a second set of back-end servers. During other times, the web request routers may route the traffic in the same manner. The load of the servers may also be used by the web request router to determine how to route the request. The load may be for a particular server and/or for a group of servers. For example, the load could be an average load across all/portion of the backend servers. Other load information may also be used (e.g. peak load, average load at different times of the day, . . . ). The WRR may be configured to either provide the load information or not provide the load information to the client.

Cache 116 may be used to store many different types of information that is used in routing requests. For example, configuration information (which might be millions of objects changing rapidly) is stored in the cache instead of being pushed into each of the web request routers. The web request router may simply obtain values from the cache. The cache 116 may also be used to store routing tables that may be used to determine where to route a particular request.

The web request routers may use many different factors to assist in routing the request, such as back-end server utilization, the number of connections to a server and overall performance to determine which back-end server receives a request. The web request routers may also use application specific logic for routing the requests. For example, the requests may be routed based on a document identifier and/or user information that is included within the received request.

The web request routers may also employ one or more of several techniques (e.g. round robin, based on load values, based on load values returned by the back ends with other requests, based on load in the cache, or based on sensing how quickly other responses have been returned) to determine the destination of the request.

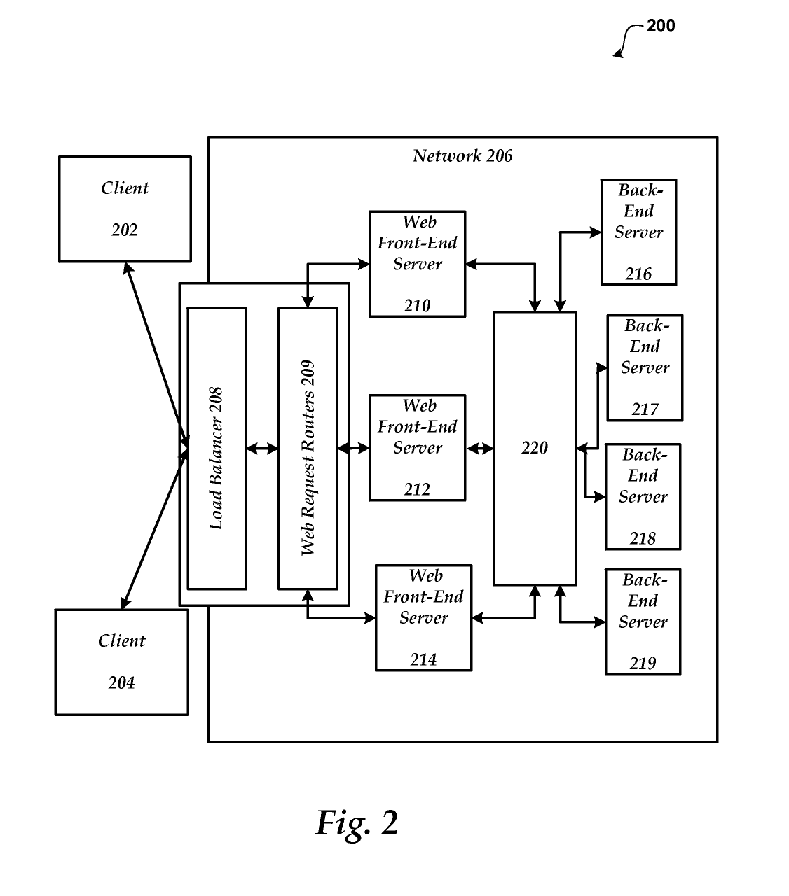

FIG. 2 shows an example system 200 for routing requests using web request routers in a network including front-end and back-end servers for an online service. The example system 200 includes clients 202 and 204, network 206, load balancer 208, web request routers 209, WFE servers 210, 212, 214, back-end servers 216-219, and optional routing component 220. Greater or fewer clients, WFEs, back-end servers, load balancers and networks can be used. Additionally, some of the functionality provided by the components in system 200 may be performed by other components. For example, load balancing may be performed in the WFEs and/or some other computing device.

In example embodiments, clients 202 and 204 are computing devices, such as desktop computers, laptop computers, terminal computers, personal data assistants, or cellular telephone devices. Clients 202 and 204 can include input/output devices, a central processing unit (“CPU”), a data storage device, and a network device. In the present application, the terms client and client computer are used interchangeably.

WFEs 210, 212 and 214 are accessible to clients 202 and 204 via load balancer 208 and web request routers 209 through network 206. One or more WFEs may change. For example, one or more WFEs may be added/deleted/changed over time. Back-end servers 216-219 are accessible to WFEs 210, 212 and 214. Load balancer 208 may be a dedicated network device and/or one or more general server computers. Load balancer 208, web request routers 209, routing component 220, WFEs 210, 212 and 214 and back-end servers 216-219 can include input/output devices, a central processing unit (“CPU”), a data storage device, and a network device. In example embodiments, network 206 is the Internet and clients 202 and 204 can access WFEs 210, 212 and 214 and resources connected to WFEs 210, 212 and 214 remotely.

In an example embodiment, system 200 is an online, browser-based cloud based system. In system 200, one or more of the back-end servers 216-219 are SQL servers, for example SQL Server from Microsoft Corporation of Redmond, Wash.

WFEs 210, 212 and 214 provide an interface between clients 202 and 204 and back-end servers 216-219. The load balancers 208 direct requests from clients 202 and 204 to web request routers. Load balancer 208 may include one or more dedicated hardware devices and/or general purpose computing devices that are configured to perform load balancing. According to an embodiment, load balancer 208 is a dedicated hardware load balancer that terminates at a layer 4 TCP/IP connection. As discussed above, the hardware load balancer may operate at a different layer (e.g. layer 3). A load balancer can generally route many more messages when it does not have to perform much processing. For example, processing Secure Sockets Layer (SSL) connections can significantly reduce a number of requests a load balancer can handle. A load balancer may be able to route many more requests at a lower layer as compared to at a higher layer (e.g. 5 times as many requests processed at the lower layer).

Web request routers 209 direct requests to WFEs 210, 212 and 214 and use factors such as WFE utilization, the number of connections to a WFE and overall WFE performance to determine which WFE server receives a client request. Similarly, web request routers 209 uses factors such as back-end server utilization, the number of connections to a server and overall performance to determine which back-end server receives a request. Web request routers 209 may be used to offload some of the processing from load balancer 208. For example, load balancer 208 may operate at a lower TCP/IP layer (e.g. layer 3,4) such that it may handle more requests. Web request routers 209 provide a scalable request router that may operate at a higher TCP/IP layer (e.g. layer 7). The web request routers may use application specific logic for routing the requests. For example, the requests may be routed based on a document identifier and/or user information that is included within the received request. When a WFE change occurs (e.g. WFE deleted/added) the web-request routers stores the changed information regarding the WFE change such that the web request routers stop sending traffic to a WFE that has been removed and directs traffic to a newly added WFE when appropriate.

An example of a client request may be to access a document stored on one of the back-end servers, to edit a document stored on a back-end server (e.g. 216-219) or to store a document on back-end server. When load balancer 208 receives a client request over network 206, load balancer 208 directs the request to one of the available web request routers 209. The web request router 209 determines which one of WFE server 210, 212 and 214 receives the client request. Similarly, WFE server 210, 212, 214 and/or optional routing component 220 determines which one or more of the back-end servers 216-219 receive a request from the WFE servers. The back-end servers may be configured to store data for one or more tenants (i.e. customer).

Client 202 and/or client 204 may change the routing of web request routers 209. For example, client 202 may set an option within a client based application that allows the client to be directed to different content (e.g. a new version of an application) such that it may be tested/previewed. The setting may also be received from another computing device (e.g. an application server).

The web request routers are run on general purpose computing devices (e.g. servers) that may include decrypting functionality that is built into the hardware. For example, many CPUs have built in decoding capability that may be utilized to help in decoding Secure Sockets layer (SSL) connections. Web request routers are generally much less expensive then dedicated load balancers (e.g. load balancer 208) for a large network. Any number of web request routers 209 may be utilized to process the requests. The number of web request routers may also dynamically change during the operation of the online service. For example, depending on the loads on the service, more or less web request routers may be automatically deployed/removed.

The web request routers 209 may use application specific logic for routing the requests. The requests may be routed based on information that is included within the request (e.g. a document identifier and/or user/document/address information). For example, a request may be an HTTP request in the form of “ . . . /wordviewer.aspx?id=foo.docx.” The request is associated with a specific application and includes a document identifier “foo.docx” as part of the request. Different applications may have different request structures. Generally, the request that is associated with an application may include items such as: application information, user information, tenant information, document information, and the like. Instead of having to modify a request to include additional information that may be used for routing, many application requests already include information that may be used in the routing. In other words, the web request routers have application specific knowledge on how an application creates requests. As such, no additional information has to be created and stored within a request since an application may already include the usable information within the request.

The routing of requests may be based on the name/type/path prefix (e.g. some portion of the URL path in the request)/site collection/address of the requested content (e.g. foo.docx, /tenant1, LOC1/*.doc, . . . ). For example, all of the requests for a specific document foo.docx may be directed a single server to handle the request to improve its ability to cache responses whereas requests to a very popular site may be directed to a group of servers. When a single server handles the requests for a document it is generally able to retrieve the requested content from cached content thereby saving time and computing resources. Once a document has been requested it may be cached on the server originally handling the request. Since requests may be routed based on the document name, there is a high likelihood that the document will be in the cache of the determined server. Other application specific information may also be used to route the requests, such as routing based on a specific version of an application, document version, a type of application, and the like.

Routing of the requests may also be based at least in part on other factors, such as: routing based on non-user initiated requests (bots); replication of requests (route to multiple end points for debugging purposes); geographic distribution (route cross network, cross data center, to achieve high availability during DNS propagation); and the like.

The document may also be cached in some other location, such as within a caching server (not shown). Caching servers accelerate requests by retrieving content saved from a previous request made by the same client or other clients. Caching servers store frequently requested resources such that they may be provided more quickly.

A look up table may be used in determining a destination for the request. For example, a look up table may be stored in a data store within the network and/or in a cache (e.g. cache 116). The look up table is accessed by a web request router to determine the destination for a request. For instance, the lookup table may include a customer name and a document name and a location of where that document is stored. Web request routers use the information from the request and look up the location of the data store for that document within the look up table. When a location of content changes within the online service, the look up table may be updated such that the web request routers automatically direct content to the updated location. As discussed, the location of content may change for many different reasons, such as new deployments of machines, farms, databases; upgrades, splitting databases, defragmentation operations, and the like.

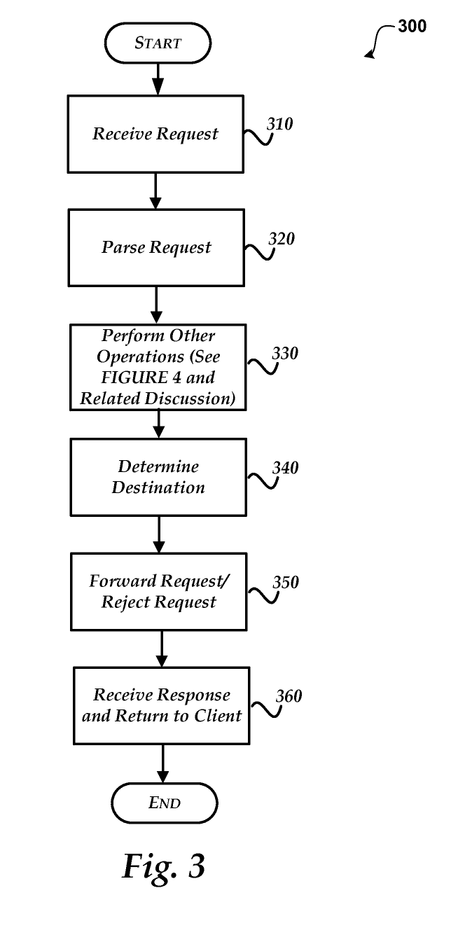

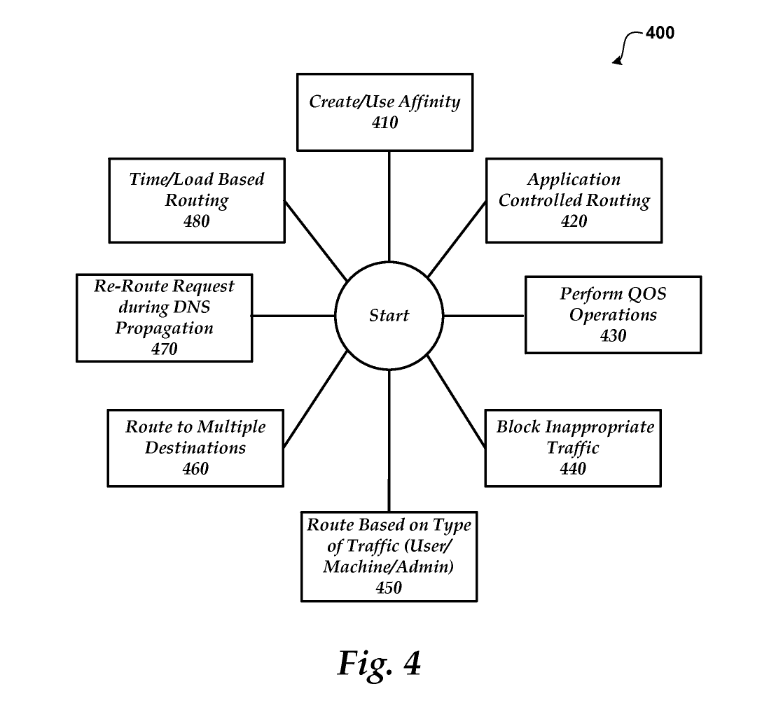

FIGS. 3-4 show a process for routing requests in an online system using web request routers.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

FIG. 3 illustrates an overview process for using web request routers to route requests.

After a start operation, the process 300 flows to operation 310, where a request is received. The request is received at a group of general purpose commodity servers that are configured as web request routers to route the request to an appropriate destination. The destination may be within/outside of the network where the web request routers reside. The requests are for content that are stored on one or more machines. The requested content may move locations. For example, a database may be copied to a new location, a tenant may be moved to a different location, a new farm may be deployed, and the like. According to an embodiment, the requests follow the HTTP protocol.

Flowing to operation 320, the request is parsed by a web request router. The request may be parsed for different types of information. For example, some requests may be parsed to: determine a name of a location within the header; identify an application that is associated with the request; identify a name of the document; identify a user; determine a setting contained within the request (i.e. application specific routing request); identify a type of the request (e.g. user/machine/administrative); identify an address; and the like. Some information that may be parsed comprises application identifying information, document information, user information, authentication information, security information, customer information and the like.

Moving to operation 330, other operations may be performed by the web request router. Many types of operations may be programmed to be performed by a web request router. A web request router may create/use affinities. For example, affinities may be created for documents, site collections, URLs, directory paths, and the like. A web request router may also perform various QOS operations (e.g. metering network traffic; auditing network traffic; logging network traffic; billing and rejecting network traffic . . . ) (See FIG. 4 and related discussion for other operations).

Transitioning to operation 340, a destination for the request is determined. As discussed, the destination may be determined using many different types of information. According to an embodiment, information about what content is available one the various back-end servers in the network is stored in a look up table that is accessible by the web request router. The lookup table reflects a current location of data. According to an embodiment, the look up table is automatically updated whenever the location of content changes so that the information the lookup table contains accurately reflects the server(s) where content is available at the time a request is made. According to an embodiment, the lookup table identifies one or more back-end servers that handles a particular document/URL/address/user/site collection. For example, one server may process a first set of documents, another server processes a particular site collection, another server processes requests that include a particular address, and the like. By sending the requests for the same content to the same machine(s), the content will likely be stored within a cache of the machine. If the request was to another server that did not have the content cached, that server then performs a lot more steps in obtaining the document. The destination may also be determined based on other information that is included within the request (e.g. a testing request that directs a web request router to another location for content). The destination for the request may also be prohibited. For example, a request may be determined to be associated with a prohibited requestor.

Moving to operation 350, the request is forwarded to the determined destination or rejected when the request is prohibited. The destination may be within/outside of the network in which the web request routers reside. In some cases (e.g. the request being large) the request may be streamed to the destination.

Flowing to operation 360, when the request is forwarded to the destination, a response is received from the destination and returned to the client. The response may be returned as received from the destination and/or modified before being returned. For example, load information, health information, and the like may be included within the response. In some cases (e.g. the response being large) the response may be streamed to the client.

The process then moves to an end block and returns to processing other actions.

FIG. 4 shows different exemplary operations that may be performed by a web request router. The exemplary operations are provided as examples and are not intended to be limiting. Zero or more of the operations of process 400 may be performed.

Operation 410 illustrates creating/using an affinity. An affinity may be created/determined for: individual files, groups of files, specific URLs, portions of a URL, specific directory paths, portions of a directory path, an application, a type of application, types of files, site collections, one or more properties of the underlying HTTP protocol such as cookies, user agent, HTTP versions and the like. An affinity may also be based on a combination of different items. For example, a web request router may associate files of the type “document” that are associated with address “Addr1” to be stored at back-end server 1.

Operation 420 shows application controlled routing. Routing a request may be based on a setting received from a client based application. A user and/or another computing device may temporarily/permanently change the routing for a request by changing a setting. For example, a user may set a testing setting using a client based application that causes the web request routers to route requests that are received from one or more users to a different version of an application/content for testing purposes. A web front-end server, or other computing device, may also change the routing.

Operation 430 illustrates using web request routers to perform QOS operations. The web request routers may be configured to perform various QOS operations (e.g. metering network traffic; auditing network traffic; logging network traffic; determining health of network; monitoring network traffic; billing and controlling network traffic). The health may relate to a health of each of a set of machines and/or an overall health for a the set of machines. For example, the web request router may determine an average health score that is based on a value that is obtained from each of the machines. In this way, a single machine value for a health score does not provide a misrepresentation of the health score for the other machines in the set (e.g. one machine may be in high demand while the other machines in the set are not).

Operation 440 shows blocking inappropriate network traffic. For example, a web request router may reject network traffic that is determined to come from an unauthorized source. In this way, the back-end servers do not receive the unauthorized traffic and spend time processing the unauthorized traffic.

Operation 450 illustrates routing based on a type of the network traffic. The request may be routed differently depending on when the request comes from a user, a machine, or the request is an administrative request. For example, a request coming from a user may be higher prioritized then a request coming from a machine. The request may also be routed differently and an affinity created based on the type of the network traffic (e.g. user based traffic to servers 1-3, machine based traffic to servers 3-4 and administrative requests to server 5). According to an embodiment, the type of network traffic is determined from a field within the request.

Operation 460 shows routing a request to multiple destinations. A request may be routed to more than one destination. For example, a request may be routed to multiple destinations for debugging purposes.

Operation 470 illustrates re-routing a request during DNS propagation. For some period of time after content is moved from one location to new location, the new location is not reflected by the Domain Name System (DNS). During this DNS propagation period, the web request router may determine the location of the content (e.g. from a lookup table (or some other location)) and re-route the request to the new location before the DNS has updated the location of the content. The re-routing may route across network, across data centers, or to another machine within the same network/data center.

Operation 480 shows routing based on a time of the request and/or a current network characteristic (e.g. load). The web request routers may route traffic based on a time of the day and/or load on the back-end server(s) that are configured to receive the request. For example, during prescribed hours of the day, requests meeting a certain condition (e.g. user traffic) are directed to a first set of back-end server whereas requests not meeting the condition are directed to a second set of back-end servers. During other times, the web request routers may route the traffic in the same manner. The load of the servers may also be used by the web request router to determine how to route the request.

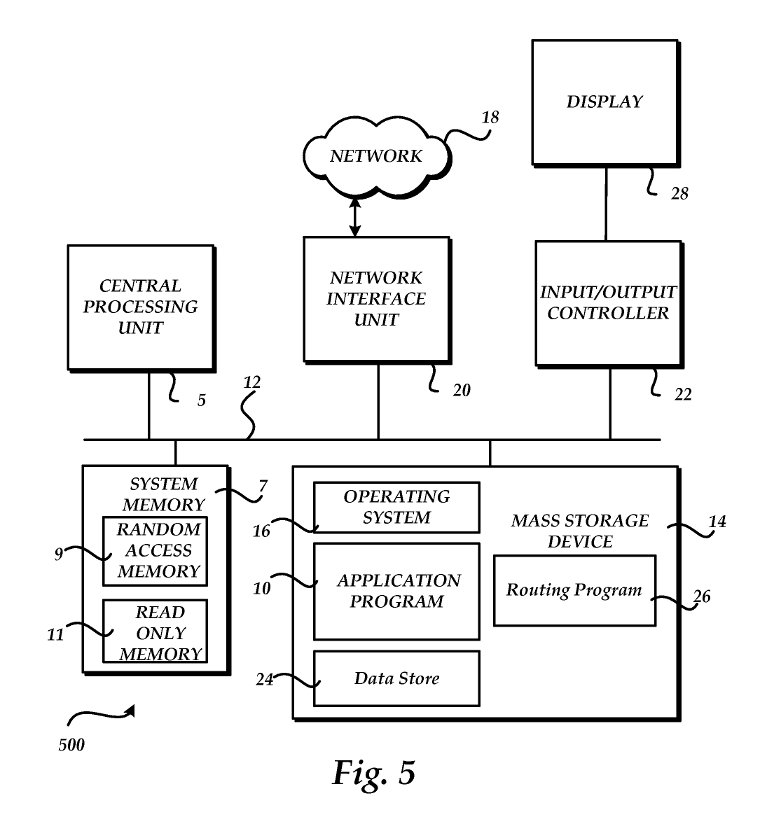

Referring now to FIG. 5, an illustrative computer architecture for a computer 500 utilized in the various embodiments will be described. The computer architecture shown in FIG. 5 may be configured as a server, a desktop or mobile computer and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 500 further includes a mass storage device 14 for storing an operating system 16, application programs 10, data store 24, files, and a routing program 26 relating to routing requests.

The mass storage device 14 is connected to the CPU 5 through a mass storage controller (not shown) connected to the bus 12. The mass storage device 14 and its associated computer-readable media provide non-volatile storage for the computer 500. Although the description of computer-readable media contained herein refers to a mass storage device, such as a hard disk or CD-ROM drive, the computer-readable media can be any available media that can be accessed by the system 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 500.

According to various embodiments, computer 500 may operate in a networked environment using logical connections to remote computers through a network 18, such as the Internet. The computer 500 may connect to the network 18 through a network interface unit 20 connected to the bus 12. The network connection may be wireless and/or wired. The network interface unit 20 may also be utilized to connect to other types of networks and remote computer systems. The computer 500 may also include an input/output controller 22 for receiving and processing input from a number of other devices, including a keyboard, mouse, or electronic stylus (not shown in FIG. 5). Similarly, an input/output controller 22 may provide output to a display screen 28, a printer, or other type of output device.

As mentioned briefly above, a number of program modules and data files may be stored in the mass storage device 14 and RAM 9 of the computer 500, including an operating system 16 suitable for controlling the operation of a networked computer, such as the WINDOWS® operating systems from MICROSOFT® CORPORATION of Redmond, Wash. The mass storage device 14 and RAM 9 may also store one or more program modules. In particular, the mass storage device 14 and the RAM 9 may store one or more application programs, such as routing program 26, that perform tasks relating to routing requests.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for routing requests to back-end servers, comprising:
receiving a request at a web request router that is a general purpose computing device;
at the web request router, parsing the request that includes interpreting the network protocol and determining a destination including a back-end server to which the request is to be routed; and
routing the request to the determined destination.

2. The method of claim 1, wherein receiving the request at the web request router comprises receiving the request from a load balancer that is a dedicated network device.

3. The method of claim 2, wherein the web request router offloads functions performed by the load balancer comprising offloading at least one of:
interpreting a network protocol of the request; decrypting security associated with the request; determining an affinity that is associated with the request and interpreting a FQDN (Fully Qualified Domain Name).

4. The method of claim 1, wherein parsing the request comprises determining an affinity that is associated with the request, wherein the affinity is associated with at least one of: a document; a directory path; a site collection; and a Uniform Resource Locator.

5. The method of claim 1, wherein parsing the request comprises determining when to route the request to a back-end server that is running a different version of an application such that a first request received from a first client for content is directed to a first destination and a second request received from a second client for the content is directed to a second location.

6. The method of claim 1, wherein parsing the request comprises determining the destination using at least one of: a time of the request and a load on a set of back-end servers.

7. The method of claim 1, further comprising performing at least one of the following using the web-request router: metering network traffic; auditing network traffic; logging network traffic; billing and rejecting network traffic.

8. The method of claim 1, further comprising using the web-request router to route the request to a different network location when content has been moved and a location of the different network location has not been updated by a Domain Name System (DNS).

9. The method of claim 1, further comprising changing a routing of the web request router based on a change received from a user based application at a client device.

10. The method of claim 1, wherein parsing the request comprises determining a type of network traffic that is associated with the request from user traffic and machine traffic and routing and prioritizing the request based on the determined type of the network traffic.

11. A computer-readable storage medium having computer-executable instructions for routing requests, comprising:
receiving a request for content in a network; wherein the request is received at a web request router from a dedicated load balancer in the network, wherein the web request router is part of a group of web request routers in the network that includes client configurable routing logic;
at the web request router, parsing the request that includes interpreting the network protocol, determining a type of network traffic that is associated with the request from user traffic and machine traffic and adjusting a routing of the request based on the determined type of the network traffic and determining a destination including a back-end server to which the request is to be routed; and
routing the request to the determined destination.

12. The computer-readable storage medium of claim 11, wherein the web request router offloads functions performed by the load balancer comprising offloading at least one of: decrypting security associated with the request; interpreting a FQDN (Fully Qualified Domain Name and determining an affinity that is associated with the request.

13. The computer-readable storage medium of claim 11, wherein parsing the request comprises determining an affinity that is associated with the request, wherein the affinity is associated with at least one of: a document; a directory path; a site collection; and a Uniform Resource Locator.

14. The computer-readable storage medium of claim 11, wherein parsing the request comprises determining when to route the request to a back-end server that is running a different version of an application such that a first request received from a first client for content is directed to a first destination and a second request received from a second client for the content is directed to a second location.

15. The computer-readable storage medium of claim 11, further comprising performing at least one of the following using the web-request router: metering network traffic; auditing network traffic; logging network traffic; billing and rejecting network traffic.

16. The computer-readable storage medium of claim 11, further comprising using the web-request router to route the request to a different network location when content has been moved and a location of the different network location has not been updated by a Domain Name System (DNS).

17. A system for routing requests in an online service, comprising:
a processor and a computer-readable medium;
an operating environment stored on the computer-readable medium and executing on the processor;
a cache that is configured to store state information for web request routers;
web request routers that are coupled to the network and the cache that are each configured to perform actions, comprising:
receiving a request for content in a network; wherein the request is received at a web request router from a dedicated load balancer in the network, wherein the web request router is part of a group of web request routers in the network that includes client configurable routing logic;
at the web request router, parsing the request that includes interpreting the network protocol, performing Quality of Service (QOS) operations for the network comprising at least one of: metering network traffic; auditing network traffic; logging network traffic; billing and rejecting network traffic; and determining a destination including a back-end server to which the request is to be routed; and
routing the request to the determined destination.

18. The system of claim 17, wherein the web request router offloads functions performed by the load balancer comprising offloading at least one of:
decrypting security associated with the request; interpreting a FQDN (Fully Qualified Domain Name and determining an affinity that is associated with the request.

19. The system of claim 17, wherein parsing the request comprises determining an affinity that is associated with the request, wherein the affinity is associated with at least one of: a document; a directory path; a site collection; and a Uniform Resource Locator.

20. The system of claim 17, further comprising using the web-request router to route the request to a different network location when content has been moved and a location of the different network location has not been updated by a Domain Name System (DNS).
